(19) United States
(12) Patent Application Publication
(10) Pub. No.: US 2008/0226374 A1
(43) Pub. Date: Sep. 18, 2008

(54) Tape cassette and tape printer

(75) Inventor: Koshiro Yamaguchi, Kakamigahara-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/069,080

(22) Filed: Feb. 7, 2008

(30) Foreign Application Priority Data
Mar. 14, 2007 (JP) 2007-065712
Mar. 14, 2007 (JP) 2007-065721

(51) Int. Cl. B65H 75/00; B41J 2/315

(52) U.S. Cl. 400/242; 400/120.01

(57) ABSTRACT

A tape cassette includes an ink ribbon provided with a base film coated with an ink layer thereon and a film tape provided with a transparent film with an adhesive layer formed on one surface thereof. When an adhesive layer of the film tape and the ink layer of the ink ribbon of the tape cassette into contact at a print position, the ink layer is adhered onto the adhesive layer on condition that the adhesive layer is heated to exhibit self-adhesive properties, and characters and the like are printed on the film tape. At a tape printing apparatus with the tape cassette mounted thereon, by arranging a cutter unit immediately downstream the thermal head, a post-printing tape is cut promptly after printing.

### CROSS-REFERENCE TO RELATED APPLICATIONS

This application is based upon and claims priorities from the prior Japanese Patent Applications No. 2007-065712 filed on Mar. 14, 2007 and No. 2007-065721 filed on Mar. 14, 2007, the entire contents of which are incorporated herein by reference.

### BACKGROUND

1. Field

On or more aspect of disclosure relate to a tape cassette including a ink ribbon having a base film on which a ink layer are formed and a printing tape formed of a transparent film having a pressure-sensitive adhesive layer formed on one surface thereof, and more particularly, the tape cassette in which an adhesive layer of the printing tape and the ink layer of the ink ribbon come into contact at a printing position, and relate to a printer using the tape cassette.

2. Description of Related Art

Various types of tape printing apparatuses have been conventionally proposed for producing a tape with characters printed thereon. Generally, a tape cassette to be used in a tape printing apparatus has a cassette case comprising a ribbon spool onto which an ink ribbon is wound, a film tape spool onto which a film tape serving as a printing medium is wound, and an adhesive tape spool onto which an adhesive tape is wound. In the above-described tape cassette, characters and the like are printed on the film tape using a thermal head provided in the tape printing apparatus, through the ink ribbon, while the ink ribbon and the film tape are being conveyed, to thereby produce a tape with characters printed thereon.

In general, to improve the scratch resistance of the characters and the like formed on the film after the printing operation in the tape printing apparatus, an adhesive tape is pasted on the character printed surface of the post-printing film tape by means of a pasting roller or the like, after which the tape is cut.

However, since the adhesive tape needs to be pasted on the character printed surface of the film tape after the characters and the like have been printed thereon, the adhesive tape spool onto which the adhesive tape is wound and the pasting roller must be accommodated in the tape cassette used in the conventional tape printing apparatus.

As a result, the size of the tape cassette becomes larger, thereby creating a problem that the overall size of the printing apparatus must inevitably be made larger to allow for installation of a cassette mounting unit. Further, since the pasting roller provided inside the tape cassette is configured so as to be arranged between the thermal head and the- cutting mechanism provided in the tape printing apparatus, the thermal head is inevitably arranged far away from the cutting mechanism. As a result, a front blank space (blank space portion corresponding to the distance between a cutting position of the printing tape and the thermal head of the tape printing apparatus) of the produced printing tape becomes large, thereby creating a problem that the amount of consumed printing tape increases which leads to a sudden increase in the running cost.

To solve the above-described problems, a tape printing apparatus is required which, in the process of pasting the adhesive tape to a character-printed surface of the film tape to thereby produce a so-called laminated-type printing tape with an improved scratch resistance of the characters and the like, employs a compact tape cassette from which the adhesive tape spool onto which the adhesive tape is wound and the pasting roller for pasting the adhesive tape onto the character-printed surface of the film tape are removed. In this tape printing apparatus, the tape cassette and the thermal head and the cutting mechanism can be arranged close to one another, which helps shorten the front blank spaces of the printing tape, thereby making it possible to reduce the running cost of the printing tape.

### SUMMARY

One or more aspects of the disclosure has been made in view of the above-described circumstances and has an object to overcome the above-described problems in the background art by providing a tape cassette in which a laminated-type printing tape can be produced without using an adhesive tape spool onto which an adhesive tape to be pasted on a character printed surface of the film tape is wound and a pasting roller for pasting an adhesive tape onto a character printed surface of the film tape.

Also, one or more aspects of the disclosure has as object to provide a printing apparatus in which the use of a tape cassette from which the adhesive tape spool and the pasting roller have been removed makes it possible to arrange the cutting mechanism immediately downstream the thermal head, and makes it possible to cut the film tape immediately after printing the characters and the like onto the film tape, thereby reducing the running cost of the film tape.

To achieve the above object, according to a first aspect of the disclosure, there is provided a tape cassette comprising: an ink ribbon having a base film coated with an ink layer thereon; a printing tape having a transparent film with an adhesive layer formed on one surface thereof; and a cassette case housing the ink ribbon and the printing tape, wherein the adhesive layer of the printing tape and the ink layer of the ink ribbon are configured so as to come into contact with each other at a printing position.

In the above lettering tape, an adhesive layer of a printing tape and ink ribbon of an ink layer is mounted so as to come into contact with each other at a printing position.

Accordingly, the adhesive layer never comes in directly contact with a thermal head or the like. Therefore, failures such as that the adhesive layer adheres the thermal head can be prevented.

According to a second aspect of the disclosure, there is also provided a tape printer comprising: a tape cassette including an ink ribbon having a base film coated with an ink layer thereon, a printing tape having a transparent film with an adhesive layer formed on one surface thereof, and a cassette case housing the ink ribbon and the printing tape; and a pair of conveying rollers conveying the printing tape discharged from a tape-discharging port of the tape cassette, wherein the adhesive layer starts exhibiting self-adhesive properties upon being heated, and the pair of conveying rollers includes a heat roller heating the printing tape discharged.

In the above lettering tape, the tape cassette from which the adhesive tape spool and the pasting roller have been removed is used. Also, cutting device is arranged and can cutting device can be arranged immediately downstream the thermal head.

Further, the printing tape discharged from a tape discharging port is conveyed through a pair of conveying rollers and simultaneously, the pressure-sensitive adhesive layer of the printing tape is heated by the heat roller in the pair of conveying rollers to exhibit adhesive properties.

Accordingly, the film tape can be immediately cut after printing the characters and the like onto the film tape. Also, a user can stick the printing tape serving as a printing label to a target object as is, without the need to peel off the release sheet therefrom. Further, since a release sheet is not used, production of waste can be suppressed.

### BRIEF DESCRIPTION OF THE DRAWINGS

The accompanying drawings, which are incorporated in and constitute a part of this specification illustrate embodiments of the disclosure and, together with the description, serve to explain the objects, advantages and principles of the disclosure.

FIG. 1 is an enlarged perspective view of a relevant part showing a mounting of a tape cassette in a cassette housing portion of a tape printing apparatus according to a first embodiment.

FIG. 2 is a plan view showing a pattern of an internal configuration of the tape cassette according to the first embodiment.

FIG. 3 is an explanatory diagram showing a pattern of the relationship between the ink ribbon and the film tape in a character printing process according to the first embodiment.

FIG. 4 is an explanatory diagram showing a pattern of a transfer mechanism in which an ink layer is transferred to an adhesive layer upon being heated by a thermal head according to a first embodiment.

FIG. 5 is an enlarged perspective view of a relevant part showing mounting of a tape cassette in a cassette housing part of a tape printing apparatus according to a second embodiment.

FIG. 6 is a plan view showing a pattern of an internal configuration of the tape cassette according to the second embodiment.

FIG. 7 is an explanatory diagram showing a pattern of a relationship between an ink ribbon and a film tape in a character printing process according to the second embodiment.

FIG. 8 is an explanatory diagram showing a pattern of a transfer mechanism in which an ink layer is transferred to an adhesive layer upon being heated by a thermal head according to the second embodiment.

FIG. 9 is an explanatory diagram showing a pattern of a transfer mechanism in which the ink layer is transferred to an adhesive layer upon being heated by the thermal head according to the second embodiment.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

### First Embodiment

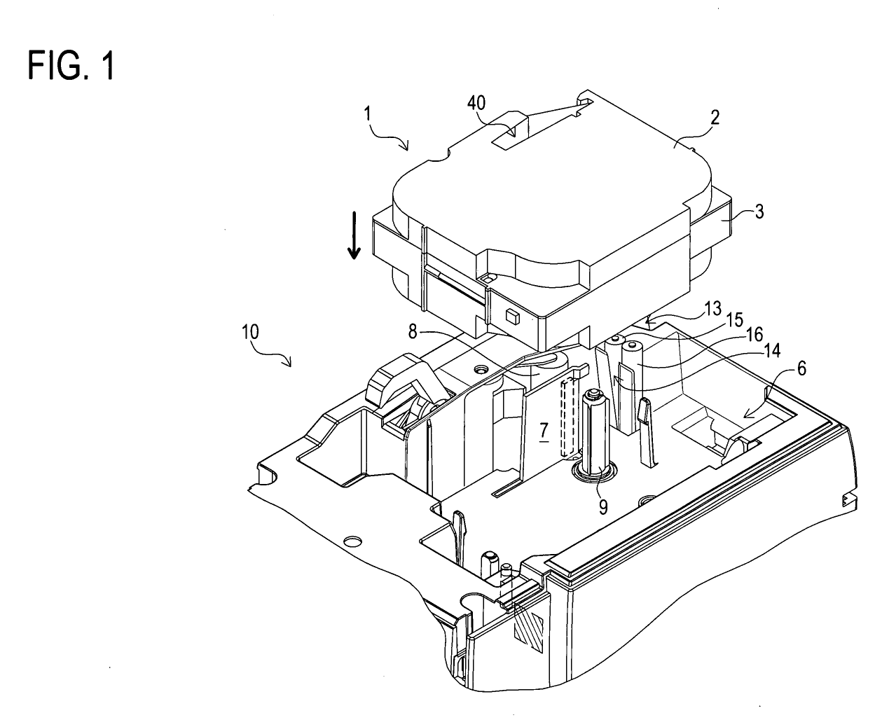

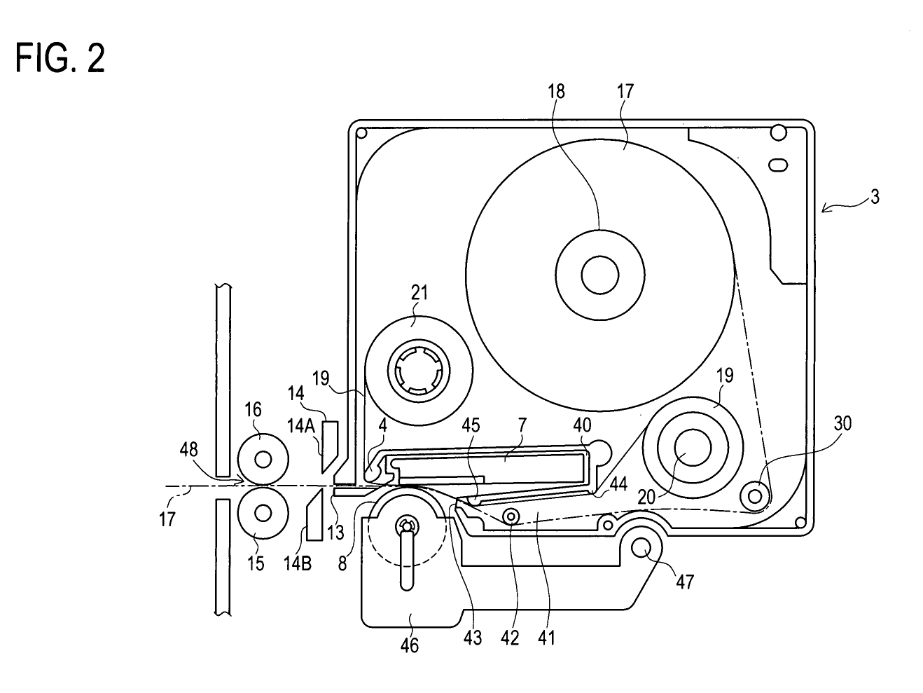

A description will now be given of a tape cassette and a tape printing apparatus according to a first embodiment, based on FIG. 1 and FIG. 2.

In FIG. 1, a tape cassette 1 is detachable in a cassette housing part 6 provided in a tape printing apparatus 10. The tape cassette 1 has an upper case 2 and a lower case 3. The upper case 2 serves as a lid member for covering an upper surface of the lower case 3. The lower case 3 has a tape spool 18 onto which a film tape 17 is wound arranged at a slightly upper position than a center part thereof, as shown in FIG. 2. The lower case 3 also has a ribbon spool 20 onto which an ink ribbon 19 is wound, and a ribbon reel-in spool 21 that draws out ink ribbon 19 from the ribbon spool 20 and reels in the ink ribbon 19 consumed in character printing, arranged at a lower right position of the tape spool 18.

The tape cassette 1 has a head insertion opening 40 formed so as to pass through the upper case 2 and the lower case 3. Upon loading the tape cassette 1 in the cassette housing part 6, a thermal head 7 to be described later is inserted in the head insertion opening 40. The head insertion opening 40 has a separating member 4 formed downstream (center left side in FIG. 2) the thermal head 7. The separating member 4 has the role of reversing the feed direction of the ink ribbon 19 which is pressed onto the film tape 17 by being clamped between a platen roller 8 and a thermal head 7 and separating the ink ribbon 19 from the film tape 17, at the time of character printing using the thermal head 7, as will be described later.

The tape cassette 1 is formed with a discharge port 13 for discharging the film tape 17 onto which characters and the like have been printed to the exterior of the cassette case 1, after the ink ribbon 19 has been separated from the film tape 17 by means of the separating member 4.

Next, a description will be given on the configuration of the tape housing part 6 in the tape printing apparatus 10. As shown in FIG. 1 and FIG. 2, the thermal head 7 is fixed in the cassette housing part 6 of the tape printing apparatus 10. The thermal head 7 is tabular with a substantially rectangular shape in a longitudinal direction thereof when viewed from the front, and has a predetermined number of heat generating elements formed at a left-hand margin at a front surface thereof, the heat generating elements being aligned along the above-described left-hand margin. The cassette housing part 6 has a platen holder 46 which is rotatably supported therein around a holder shaft 47. The platen holder 46 has a platen roller 8 rotatably supported therein. The platen holder 46 is biased in a counterclockwise direction around the holder shaft 47 by an elastic member which is not shown to be driven in a clockwise direction by a motor or the like at the time of printing onto the film tape 17. This enables the platen roller 8 to come in contact with or move away with respect to the thermal head 7.

The cassette housing part 6 has a ribbon reel-in shaft 9 that is coupled to the ribbon reel-in spool 21 of the tape cassette 1. The ribbon reel-in shaft 9 is coupled to a driving mechanism such as a motor and the like which is not shown and is adapted to drive and rotate the ribbon reel-in spool for taking up ink ribbon 19 which has been separated from the film tape 17 by means of the separating member 4, as described in the above text.

The cassette housing part 6 has a clipper-type cutter unit 14 arranged adjacent the tape discharge port 13 of the tape cassette 1. The cutter unit 14 is composed of a fixed blade 14A and a movable blade 14B which is actuated with respect to the fixed blade 14A to cut the post-printing film tape 17.

A pair of conveying rollers 48 are arranged downstream the cutter unit 14. The conveying rollers 48 are composed of a heat roller 15 that heats the adhesive layer (to be described later) formed in the film tape 17 and a tape feeding roller 16 arranged opposite the heat roller 15 and adapted to feed the post-printing film tape 17 to the exterior of the tape printing apparatus 10 through the cooperation with the heat roller.

Upon loading the tape cassette 1 having the above-described configuration in the cassette housing part 6 of the tape printing apparatus 10 to thereby print characters and the like onto the film tape 17, the film tape 17 wound onto the tape spool 18 is guided from a tape guiding skid 30 provided at a corner of the lower case 3 over a guiding pin 42 formed in an arm part 41 at an inner wall of the lower case 3, and through an opening 43 of the arm part 41, towards the thermal head 7 and the platen roller 8. The ink ribbon 19 is guided through the opening 43 towards the thermal head 7 and the platen roller 8 while being regulated by regulating protruding parts 44 and 45 of the arm part 41.

The film tape 17 and the ink ribbon 19 guided as described in the above text are superimposed between the thermal head 7 and the platen roller 8. Each of the heat generating elements of the thermal head 7 is driven to generate heat, with the film tape 17 being superimposed on the ink ribbon 19. As a result, characters and the like are printed onto the film tape 17 through the ink ribbon 19. Thereafter, the ink ribbon 19 is fed downstream the thermal head 7, and after being separated from the film tape 17 through the separating member 4, it is reeled in by the ribbon reel-in spool 21.

After characters and the like are printed onto the film tape through the ink ribbon 19 and the thermal head 7, and the ink ribbon 19 is separated therefrom through the separating member 4, the film tape 17 is discharged to the exterior of the tape cassette 1 from the tape discharging port 13 and is further discharged to the exterior of the tape printing apparatus 10 through the pair of conveying rollers 48. At this time, the adhesive layer of the film tape 17 is heated by the heat roller 15 of the pair of conveying rollers 48, thereby making the adhesive layer exhibit adhesive properties as will be described later.

Then, when the film tape 17 has reached a predetermined length, the cutter unit 14 is driven to cut the film tape 17 at a predetermined length through the cooperation of the fixed blade 14A and the movable blade 14B.

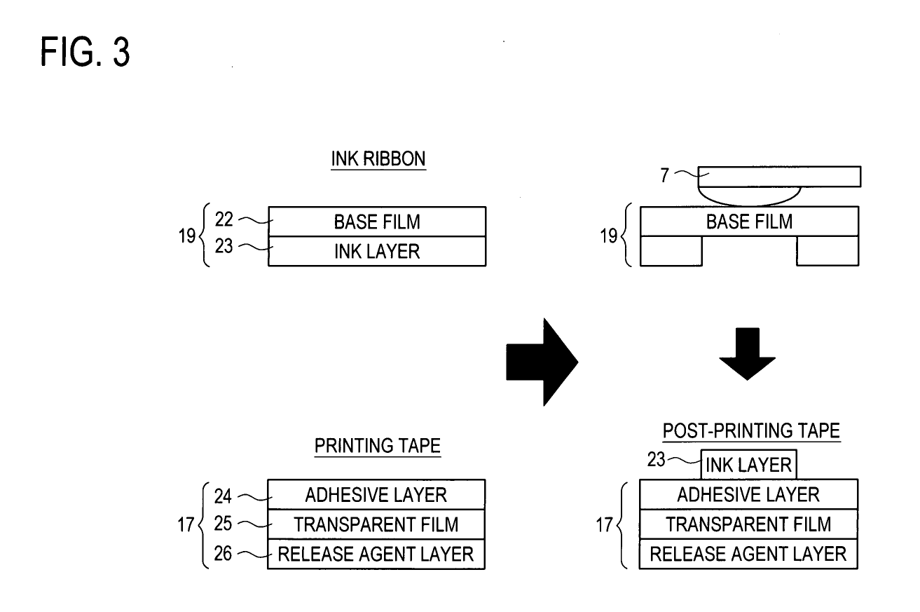

Next, the configuration of the ink ribbon and the printing tape according to the first embodiment will be described based on FIG. 3. As shown in FIG. 3, the ink ribbon 19 includes a base film 22 and an ink layer 23. The film tape 17 having the role of a printing tape has an adhesive layer 24 formed on one surface (upper side of the transparent film in FIG. 3) of a transparent film tape 25 and a release agent layer 26 formed on the other surface (lower side of the transparent film in FIG. 3) of the transparent film tape 25.

The above-described adhesive layer 24 includes a material having special properties in that it does not exhibit adhesive properties at ambient temperature, but starts exhibiting adhesive properties upon being heated, and maintains these adhesive properties after it has been heated once, even if its temperature decreases. This adhesive agent 24 may include an adhesive agent employed for heat seal labels, as described in U.S. Pat. No. 5,614,928, for instance. This type of adhesive agent melts upon being heated to 80° C. to 100° C. by the heat roller and the like, thereby exhibiting adhesive properties. In the first embodiment, the heat roller 15 heats the adhesive agent up to 80° C. or more but below 90° C.

The above-described film tape 17, having the adhesive layer 24 superimposed on a single side of the transparent film tape 25, is wound for loading in the tape spool 18 with the adhesive layer 24 at an inner side and the release agent layer 26 of the transparent film 25 at an outer side. Since the adhesive layer 24 is wound through the release agent layer 26, direct adherence of the adhesive layer 24 to the transparent film 25 can be avoided.

The film tape 17 drawn from the tape spool 18 is conveyed from the tape guiding skid 30 and the like up to a printing position found between the thermal head 7 and the platen roller 8 of the tape printing apparatus 10, as was described earlier. The film tape 17 is superimposed onto the ink ribbon 19 at the printing position, whereby the adhesive layer 24 of the film tape 17 comes in contact with the ink layer 23 of the ink ribbon 19.

When the adhesive layer 24 of the film tape 17 comes in contact with the ink layer 23 of the ink ribbon 19, the location at which the adhesive layer 24 contacts the ink layer 23 is clamped between the thermal head 7 and the platen roller 8. As shown in FIG. 3, when the thermal head 7 is brought in contact with the other surface (back surface side of the ink layer 23) of the base film 22, the ink layer 23 of the ink ribbon 19 melts under the heat from the thermal head 7, thereby making the adhesive layer 24 exhibit adhesive properties. The melted ink layer 23 is adhered to the adhesive layer 24, whereby characters and the like are transferred to the film tape 17.

The tape printing apparatus 10 is provided with a drive control apparatus (not shown) for driving and controlling the heat generating parts of the thermal head. Thus, since control is carried out so that the transferred ink layer 23 is printed as mirror image with respect to the film tape 17, characters and the like printed as a normal image can be visually checked when looking from the side of the transparent film tape 25 of the film tape 17.

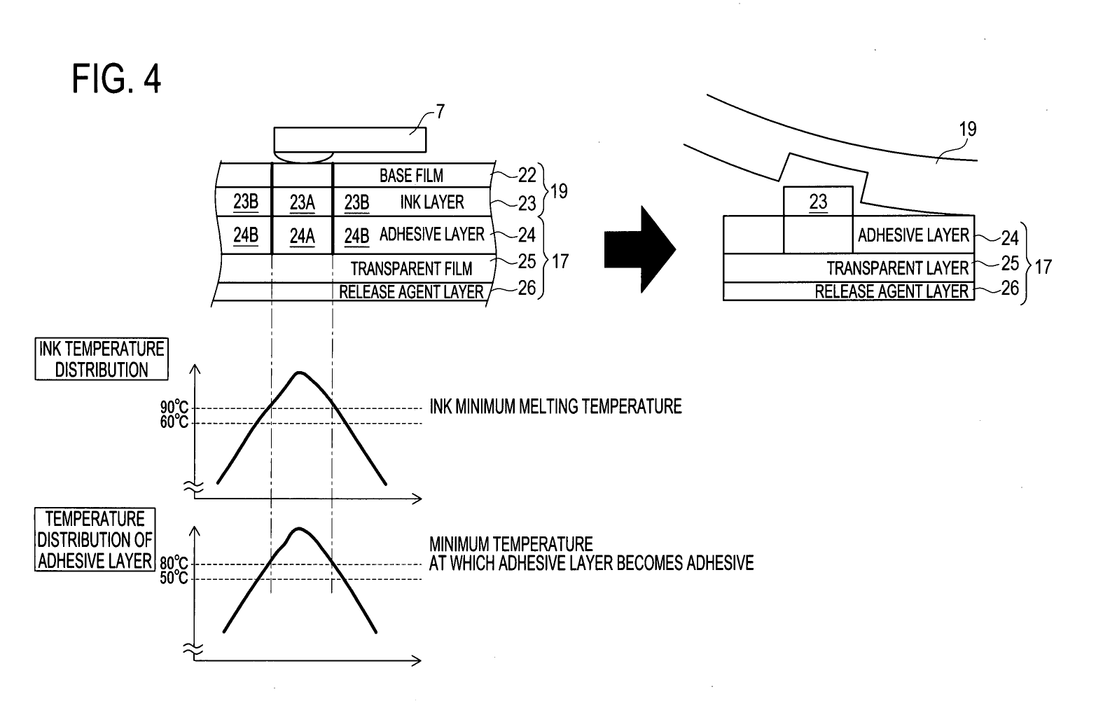

Next, a transfer mechanism in which an ink layer is transferred to an adhesive layer upon being heated by a thermal head 7 will be described based on FIG. 4. As shown in FIG. 4, when the film tape 17 and the ink ribbon 19 are superimposed at a printing position between the thermal head 7 and the platen roller 8, the adhesive layer 24 of the film tape 17 is brought in contact with the ink layer 23 of the ink ribbon 19. Although the ink layer 23 and the adhesive layer 24 are simultaneously heated at the above described contact portion by the thermal head 7, heat transfer loss occurs at the boundary portion when heat is transferred from the ink layer 23 to the adhesive layer 24, which leads to differences in temperature at the boundary part of the adhesive layer 24 and the ink layer 23. Since the ink layer 23 of the ink ribbon 19 to be used in the tape cassette 1 according to the first embodiment employs a high melting point-type ink which melts at a temperature of 90° C. or above, and the adhesive layer 24 of the film tape 17 employs an adhesive agent that exhibits adhesive properties when heated to 80° C. or above, when the temperature at a heated portion of the ink layer 23A becomes 90° C. or above, the temperature at a heated portion of the pressure-sensitive layer 24A as well, becomes 80° C. or above, and as a result, the ink layer 23A and the adhesive layer 24A are adhered at their heated portions, respectively.

Since the temperature of the adhesive layer 24B when it is not heated by the thermal head 7 is below 80° C. and thus exhibits no adhesive properties, and the temperature of the ink layer 23B at a portion corresponding to the adhesive layer 24B, as well, is below 90° C., after these layers pass the thermal head 7 and the separating part 4 arranged downstream the thermal head 7, they are heated and only the ink layer 23A which has been adhered to the adhesive layer 24A is transferred to the film tape 17, as shown in FIG. 4. The remaining portions of the ink ribbon are reeled in by the ribbon reel-in spool 21, as consumed ink ribbon 19.

As shown in FIG. 4, the thermal head 7 has a heat concentrated-type glaze structure. The ink layer 23 and the adhesive layer 24 are heated by focusing the heat into a pin-point. Accordingly, since the temperature difference between the heated portions of the ink layer 23A and the adhesive layer 24A and the unheated portions of the ink layer 23B and the adhesive layer 24B becomes large, the ink layer and the adhesive layer can be adhered, with the boundary between the heated portions 23A and the unheated portions 23B of the ink layer and the heated portion 24A and the unheated portion 24B of the adhesive layer 24A clearly defined.

The ink layer 23 includes a wax-type ink so that only the heated portions of the ink later 23 are transferred, even if they cool down after being heated. Accordingly, the heated ink layer 23 can be reliably adhered to the adhesive agent 24A at the heated portion even if the ink 23 cools down, thereby being reliably transferred to a film tape 17 onto which characters and the like are printed.

The film tape 17 onto which characters and the like are printed is drawn up to a clipper-type cutter unit 14 serving as a cutting device, through the cooperation of the tape feeding roller 16 and the heat roller 15 as described above. The post-printing film tape 17 can be cut to a predetermined length through the cooperation of the fixed blade 14A and the movable 14B of the cutter unit 14. The cut film tape 17 is passed between the tape feeding roller 16 and the heat roller 15 where it is heated by the heat roller to exhibit adhesive properties in the adhesive layer 24B at portions other than portions where the ink layer 23 is adhered. Thereafter, the post-printing film tape 17 which exhibits adhesive properties is discharged to the exterior of the tape printing apparatus 10, as a linerless tape as cut.

As described in the above, since the tape cassette 1 does not house the adhesive tape spool and the pasting roller and the tape feeding roller 16 and the heat roller 15 are arranged downstream of the cutter unit 14, the post-printing film tape 17 can be cut by the cutter unit 14 arranged immediately downstream of the thermal head 7 immediately after characters and the like have been printed thereon. This makes it possible to shorten the front blank spaces of the post-printing film tape 17, thereby reducing the running cost of the film tape 17.

Further, since the heat roller 15 heats the target layers to 80° C. or above but below 90° C., but the ink to be used is a high melting point-type ink (the melting point of the ink is 90° C. or above), the heat roller 15 does not melt the ink that is adhered to the adhesive layer 24, thereby eliminating the risk of faulty printing caused by ink melting and the like.

Since the heat roller 15 is brought in contact with the tape film 17 from the side of the release agent layer 26 (the back surface side of the adhesive layer 24) of the post-printing film tape 17, direct contact between the heat roller 15 and the adhesive layer can be avoided, thereby preventing adherence of the heated pressure-sensitive layer 24 to the heat roller 15.

Since the heated adhesive layer 24 maintains its adhesive properties even after its temperature decreases, the linerless tape produced as described above is pasted onto the target body as is, through the adhesive layer 24. As a result, the user does not have to remove the release sheet, as was done in the case of using the conventional laminated tape. Further, since the characters and the like in the transferred ink layer 23 are printed as mirror image with respect to the film tape 17, the user can recognize the characters printed as normal image, through the transparent film. Here, the release adhesive layer is also transparent. Needless to say, the adhesive layer present between the film layer and the ink layer is necessarily transparent or semi-transparent, to thus make the ink layer visible through the transparent film.

### Second Embodiment

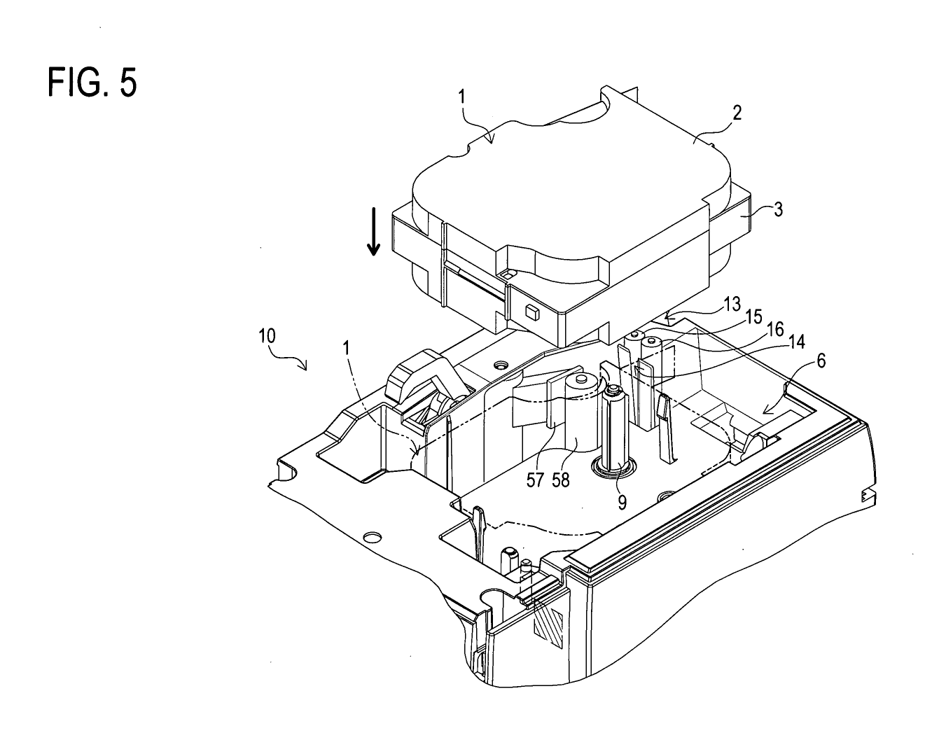

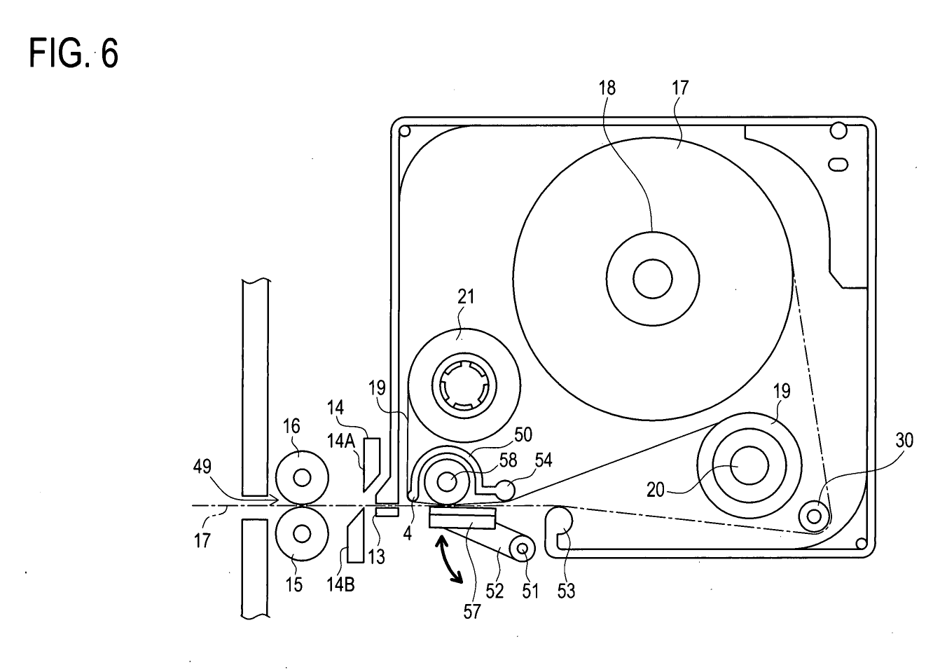

Next, a tape cassette and a tape printing apparatus according to a second embodiment will be described based on FIG. 5 and FIG. 6.

A tape cassette and a tape printing apparatus according to the second embodiment have the same basic configuration as the tape cassette 1 and the tape printing apparatus 10 according to the first embodiment. Consequently, in the description to follow, elements which are the same as those in the tape cassette 1 and the tape printing apparatus 10 according to the first embodiment will be denoted by the same numerical symbol, the description will be focused on elements that differ from those in the tape cassette 1 and the tape printing apparatus 10 according to the first embodiment.

In FIG. 5, a tape cassette 1 having an upper case 2 and a lower case 3 is detachable in the cassette housing part 6 provided in a tape printing apparatus 10. The upper case 2 serves as a lid member that covers an upper surface of the lower case 3. The lower case 3 has a tape spool 18 onto which the film tape 17 is wound, arranged at a slightly upper position from its center, as shown in FIG. 6. The lower case 3 has a ribbon spool 20 onto which the ink ribbon 19 is wound, arranged at a slightly lower right position of the tape spool 18. The lower case 3 also has a ribbon reel-in spool 21 which draws the ink ribbon 19 from the ribbon spool 20 and reels in the ink ribbon 10 which was used in character printing.

The tape cassette 1 has a roller arranging part 50 formed so as to penetrate the upper case 2 and the lower case 3. Upon loading the tape cassette 1 in the cassette housing part 6, the platen roller 58 to be described later is arranged in the roller arranging part 50. The roller arranging part 50 has a separating member 4 formed downstream the thermal head 57 (center left side in FIG. 6). As will be described later, at the time of character printing by means of the thermal head 57, the separating member 4 has the role of reversing the feed direction of the ink ribbon 19 which is pressed onto the film tape 17 when clamped between the platen roller 58 and the thermal head 57 and separating the ink ribbon 19 from the film tape 17.

The tape cassette 1 has a discharge port 13 formed therein for discharging the film tape 17 onto which characters and the like have been printed to the exterior of the cassette case 1 after the ink ribbon 19 has been separated therefrom by means of the separating member 4.

The configuration of the tape housing part 6 in the tape printing apparatus 10 will now be described. As shown in FIG. 5 and FIG. 6, the cassette housing part 6 of the tape printing apparatus 10 has a thermal head 57 mounted in the head supporting member 52 which is arranged so as to be able to rotate around the head supporting shaft 51. The thermal head 57 is tabular with a substantially rectangular shape in a longitudinal direction thereof when viewed from the front as shown in FIG. 6, and has a predetermined number of heat generating elements formed at a left margin of a front surface thereof and aligned along the left margin. The cassette housing part 6 has a platen roller 58 rotatably supported therein.

The head supporting member 52 is biased in a counterclockwise direction around the head supporting shaft 51 by means of an elastic member which is not shown. At the time of printing onto the film tape 17, the head supporting member 52 is driven in a clockwise direction by means of a motor or the like, thereby enabling the thermal head 57 to come in contact and move away with respect to the platen roller 58.

The cassette housing part 6 has a ribbon reel-in shaft 9 that is coupled to the ribbon reel-in spool 21 of the tape cassette 1. The ribbon reel-in shaft 9 is coupled to a driving mechanism such as a motor and the like which is not shown and is adapted to drive and rotate the ribbon reel-in spool for taking up ink ribbon 19 which has been separated from the film tape 17 by means of the separating member 4, as described in the above text.

The cassette housing part 6 has a clipper-type cutter unit 14 arranged adjacent the tape discharge port 13 of the tape cassette 1. The cutter unit 14 is composed of a fixed blade 14A and a movable blade 14B which is actuated with respect to the fixed blade 14A to cut the post-printing film tape 17.

A pair of conveying rollers 48 are arranged downstream the cutter unit 14. The conveying rollers 48 are composed of a heat roller 15 that heats the adhesive layer (to be described later) formed in the film tape 17 and a tape feeding roller 16 arranged opposite the heat roller 15 and adapted to feed the post-printing film tape 17 to the exterior of the tape printing apparatus 10 through the cooperation with the heat roller 15.

When the tape cassette 1 having the above-described configuration is loaded in the cassette housing part 6 of the printing apparatus 10 for character printing onto the film tape 17, the film tape 17 wound onto the tape spool 18 is guided over the tape guiding skid 30 provided at a corner of the lower case 3 and a guiding supporting part 53 formed in an inner wall of the lower case 3 towards the thermal head 57 and the platen roller 58. Also, the ink ribbon is guided toward the thermal head 57 and the platen roller 58 while being guided and supported by the guiding supporting part 54 formed at an end part of the roller arranging part 50.

The film tape 17 and the ink ribbon 19 guided as described in the above text are superimposed between the thermal head 7 and the platen roller 8. Each of the heat generating elements of the thermal head 7 is driven to generate heat, with the film tape 17 being superimposed on the ink ribbon 19. As a result, characters and the like are printed onto the film tape 17 through the ink ribbon 19. Thereafter, the ink ribbon 19 is fed downstream the thermal head 7, and after being separated from the film tape 17 through the separating member 4, it is reeled in by the ribbon reel-in spool 21.

After characters and the like are printed onto the film tape through the ink ribbon 19 and the thermal head 7, and the ink ribbon 19 is separated therefrom through the separating member 4, the film tape 17 is discharged to the exterior of the tape cassette 1 from the tape discharging port 13 and is further discharged to the exterior of the tape printing apparatus 10 through the pair of conveying rollers 48. At this time, the adhesive layer of the film tape 17 is heated by the heat roller 15 of the pair of conveying rollers 48, thereby making the adhesive layer exhibit adhesive properties as will be described later.

Then, when the film tape 17 has reached a predetermined length, the cutter unit 14 is driven to cut the film tape 17 at a predetermined length through the cooperation of the fixed blade 14A and the movable blade 14B.

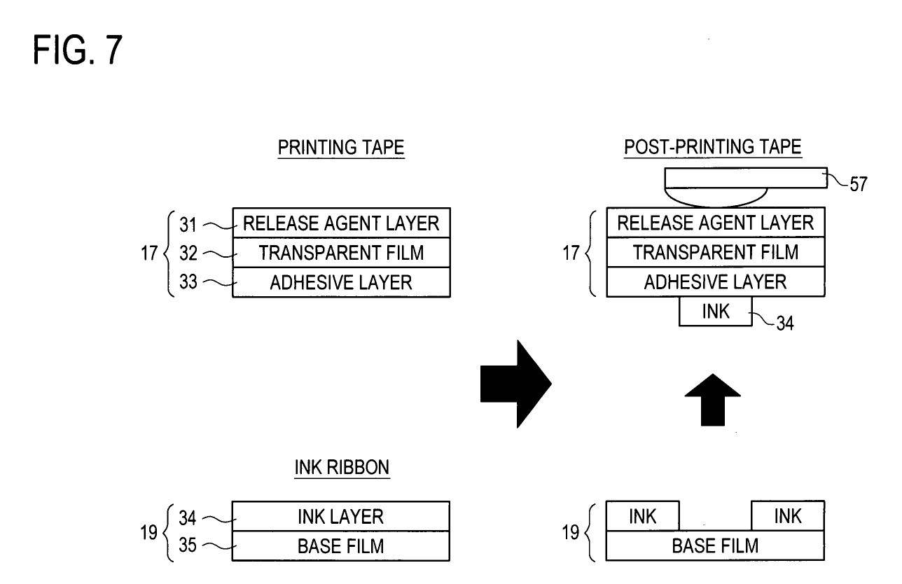

The configuration of the ink ribbon and the printing tape according to the second embodiment will now be described based on FIG. 7. As shown in FIG. 7, the ink ribbon 19 is composed of a base film 35 and an ink layer 34. The film tape 17 serving as a printing tape has an adhesive layer 33 formed on one surface (in FIG. 7, lower side of the transparent film) of the transparent film tape 32, and a release adhesive layer 31 formed on the other surface (upper side of the transparent film in FIG. 7) of the transparent film 17.

The above-described adhesive layer 33 is constructed from a material having special properties in that it does not exhibit adhesive properties at ambient temperature, but starts exhibiting adhesive properties upon being heated, and maintains these adhesive properties after it has been heated once, even if its temperature decreases. Similarly with the above-described first embodiment, the adhesive agent 24 may include an adhesive agent employed for heat seal labels, as described in Japanese Patent Publication Num. 3394572, for instance. This type of adhesive agent melts upon being heated to 80° C. to 100° C. by the heat roller and the like, thereby exhibiting adhesive properties. In the second embodiment, the heat roller heats the adhesive agent up to 80° C. or above but below 90° C., similarly with the first embodiment.

The above-described film tape 17, having the adhesive layer 33 superimposed on a single surface thereof, is wound in the tape spool 18 with the adhesive layer 33 at the inner side, for loading. Since the film tape 17 has a release agent layer 31 formed on a back surface side of the pressure-adhesive layer 33 of the transparent film tape 32, the adhesive layer 33 never adheres to the transparent film 17, to an inner side of the tape cassette and to other parts in the printing apparatus, even in the case a part of the adhesive layer should exhibit adhesive properties when it is already wound onto the tape spool 18.

The film tape 17 drawn from the tape spool 18 is conveyed from the tape guiding skid 30 and the like up to a printing position found between the thermal head 7 and the platen roller 8 of the tape printing apparatus 10, as was described earlier. The film tape 17 is superimposed onto the ink ribbon 19 at the printing position, whereby the adhesive layer 24 of the film tape 17 comes in contact with the ink layer 23 of the ink ribbon 19.

As described in the above text, when the adhesive layer 33 of the film tape 17 and the ink layer 34 of the ink ribbon 19 come in contact, the contact location where the adhesive layer 33 and the ink layer 34 come in contact with each other is clamped between the thermal head 57 and the platen roller 58 and, as shown in FIG. 7, the thermal head 57 comes in contact with the release adhesive layer 31 side of the base film 32. As a result, the adhesive layer 33 exhibits adhesive properties upon being heated by the thermal head 57 and the ink layer 34 of the ink ribbon 19 melts upon being heated by the thermal head 57. The melted ink layer 34 is adhered to the adhesive layer, whereby characters and the like are transferred to the film tape 17.

The tape printing apparatus 10 is provided with a drive control apparatus (not shown) for driving and controlling the heat generating parts of the thermal head 57. Thus, since control is carried out so that the transferred ink layer 23 is printed as mirror image with respect to the film tape 17, characters and the like printed as a normal image can be visually checked when looking from the side of the transparent film tape 25 of the film tape 17.

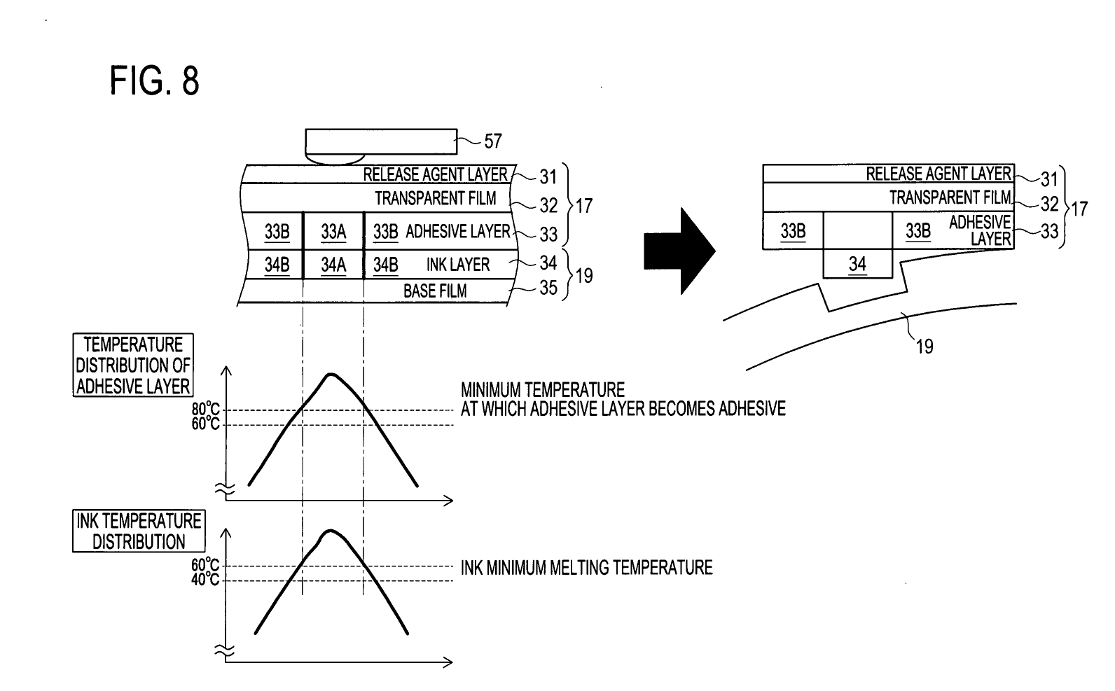

A transfer mechanism in which an ink layer is transferred to an adhesive layer upon being heated by the thermal head 57 will now be described based on FIG. 8. As shown in FIG. 8, when the film tape 17 and the ink ribbon 19 are superimposed at a printing position, between the thermal head 57 and the platen roller 58, the adhesive layer 33 of the film tape 17 is brought in contact with the ink layer 34 of the ink ribbon 19. Although the adhesive layer 33 and the ink layer 34 are simultaneously heated at the above described contact part by the thermal head 57, heat transfer losses occur at the boundary portion when heat is transferred from the adhesive layer 33 to the ink layer 34, which leads to differences in temperature at the boundary part of the ink layer 34 and the adhesive layer 33. Since the adhesive layer 33 of the film tape 17 to be used in the tape cassette 1 according to the second embodiment employs an adhesive agent that exhibits adhesive properties when heated to 80° C. or above, and the ink layer 34 of the ink ribbon 19 employs a high melting point-type ink which melts at a temperature of 60° C. or above, when the temperature at a heated portion of the adhesive layer 33A becomes 80° C. or above, the temperature at a heated portion of the ink layer 34A as well, becomes 60° C. or above. As a result, the adhesive layer 33A and the ink layer 34A are adhered at their heated portions, respectively.

Since the temperature of the adhesive layer 24B when it is not heated by the thermal head 7 is below 80° C. and thus exhibits no adhesive properties, and the temperature of the ink layer 23B at a portion corresponding to the adhesive layer 24B, as well, is below 90° C., after these layers pass the thermal head 7 and the separating part 4 arranged downstream the thermal head 7, they are heated and only the ink layer 23A which has been adhered to the adhesive layer 24A is transferred to the film tape 17, as shown in FIG. 8. The remaining portions of the ink ribbon are reeled in by the ribbon reel-in spool 21, as consumed ink ribbon 19.

As shown in FIG. 7, the thermal head 7 has a heat concentrated-type glaze structure. The ink layer 23 and the adhesive layer 24 are heated by focusing the heat into a pin-point. Accordingly, since the temperature difference between the heated portions of the ink layer 23A and the adhesive layer 24A and the unheated portions of the ink layer 23B and the adhesive layer 24B becomes large, the ink layer and the adhesive layer can be adhered, with the boundary between the heated portions 23A and the unheated portions 23B of the ink layer and the heated portion 24A and the unheated portion 24B of the adhesive layer 24A clearly defined.

The ink layer 23 includes a wax-type ink so that only the heated portions of the ink later 23 are transferred, even if they cool down after being heated. Accordingly, the heated ink layer 23 can be reliably adhered to the adhesive agent 24A at the heated portion even if the ink 23 cools down, thereby being reliably transferred to a film tape 17 onto which characters and the like are printed.

The film tape 17 onto which characters and the like are printed is drawn up to a clipper-type cutter unit 14 serving as a cutting device, through the cooperation of the tape feeding roller 16 and the heat roller 15 as described above. The post-printing film tape 17 can be cut to a predetermined length through the cooperation of the fixed blade 14A and the movable 14B of the cutter unit 14. The cut film tape 17 is passed between the tape feeding roller 16 and the heat roller 15 where it is heated by the heat roller to exhibit adhesive properties in the adhesive layer 24B at portions other than portions where the ink layer 23 is adhered. Thereafter, the post-printing film tape 17 which exhibits adhesive properties is discharged to the exterior of the tape printing apparatus 10, as a linerless tape as cut.

As described in the above, since the tape cassette 1 does not house the adhesive tape spool and the pasting roller and the tape feeding roller 16 and the heat roller 15 are arranged downstream of the cutter unit 14, the post-printing film tape 17 can be cut by the cutter unit 14 arranged immediately downstream of the thermal head 7 immediately after characters and the like have been printed thereon. This makes it possible to shorten the front blank spaces of the post-printing film tape 17, thereby reducing the running cost of the film tape 17.

Further, when the heat roller 15 heats the target layers to 80° C. or above but below 90° C., the temperature inside the ink layer becomes 60° C. or above, but because the ink used in the ink layer 34 is a low melting point-type ink (the melting point of the ink becomes 60° C. or above), the ink is once fused in the adhesive agent having high adhesiveness at the time of character printing. As a result, melting of the ink under the heat from the heat roller 15 becomes difficult, thereby eliminating the risk of faulty printing caused by ink re-melting when being heated by the heat roller 15.

Since the heat roller contacts the film tape 17 onto which characters and the like have been printed from the release agent layer 31 side thereof (back surface side of the adhesive layer 33), it is possible to avoid direct contact with the adhesive layer 33, thereby preventing the heated adhesive layer 33 from adhering to the heat roller 15. Also, Release treatment (silicon treatment or the like) has been applied onto the tape feeding roller 16 which contacts directly with the adhesive layer 33, thereby eliminating the risk of an adhesion of the adhesive layer 33 to the tape feeding roller 16.

Since the heated adhesive layer 33 maintains its adhesive properties even after its temperature decreases, the user can paste the linerless tape produced as described above onto the target body. As a result, the user no longer needs to remove the release sheet, as was done in the case of using the conventional laminated tape. Further, since the transferred ink layer 34 is printed as mirror image with respect to the film tape 17, as described in the above text, the user can recognize the characters and the like printed as normal image, through the transparent film.

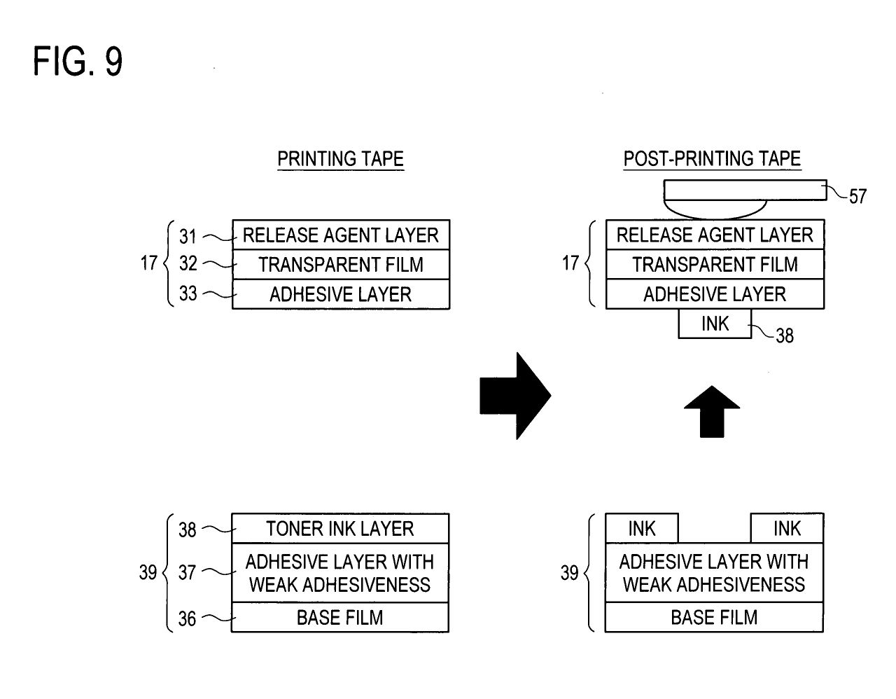

The disclosure is not limited to the above-described first embodiment to fourth embodiment, and needless to say, various alterations and modifications can be made thereto without departing from the scope of the disclosure. For instance, in the second embodiment, the ink ribbon 19 employs a thermofusion-type thermal ink ribbon, but can also employ a toner ink ribbon 39 comprising a toner ink layer 38 which has toner ink applied on one surface thereof through a adhesive layer having weak adhesive properties with respect to the base film 36 as shown in FIG. 9.

According to a transfer mechanism in which an ink layer is transferred to the adhesive layer upon being heated by the thermal head 57, the adhesive layer 33A of the film tape 17 heated by the thermal head 57, similarly with FIG. 8, is heated to a to a temperature of 80° C. or above but below 90° C. which is equal to or higher than its melting temperature, thereby exhibiting adhesive properties. Then, the toner ink layer 38 of the toner ink ribbon 39 which came in contact with the adhesive layer 33A of the film tape 17 is adhered to the adhesive layer 33A, thereby being transferred to the film tape 17. In this case, the toner ink does not melt at a temperature below 90° C. and is transferred to the film tape 17 in a powdery state.

The post-printing film tape 17 passes between the tape feeding roller 16 and the heat roller 15, and upon being heated by the heat roller 15 to 80° C. or above but below 90° C., its adhesive layer 33B exhibits adhesive properties, and the toner ink is kept in a transferred state to the film tape 17 without melting.

Accordingly, heating of the post-printing film tape 17 does not cause the ink to melt, thereby eliminating the risk of faulty printing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A tape cassette comprising:
an ink ribbon having a base film coated with an ink layer thereon;
a printing tape having a transparent film with an adhesive layer formed on one surface thereof; and
a cassette case housing the ink ribbon and the printing tape, wherein
the adhesive layer of the printing tape and the ink layer of the ink ribbon are configured so as to come into contact with each other at a printing position.

2. The tape cassette according to claim 1, wherein the adhesive layer starts exhibiting self-adhesive properties upon being heated.

3. The tape cassette according to claim 2, wherein the adhesive layer maintains self-adhesive properties even if a temperature decreases after being heated.

4. The tape cassette according to claim 2, wherein a temperature at which an adhesive agent making up the adhesive layer starts exhibiting self-adhesive properties is lower than a temperature at which an ink making up the ink layer of the ink ribbon melts.

5. The tape cassette according to claim 2, wherein
the tape cassette can be mounted onto or removed from a tape printer having a thermal head and a platen roller,
a contact location where the adhesive layer and the ink layer come into contact with each other is clamped between the thermal head and the platen roller when the tape cassette is mounted onto the tape printer,
the thermal head comes into contact at the contact location with a surface opposite to a surface coated with the ink at the ink ribbon, and
the ink layer of the ink ribbon is adhered onto a heated portion of the adhesive layer which exhibits self-adhesive properties upon being heated selectively by the thermal head.

6. The tape cassette according to claim 5, further comprising:
an ink ribbon reel-in spool reeling in the ink ribbon; and
a separating member separating the ink ribbon and the printing tape downstream in a tape-conveying direction of the printing position, wherein
the ink layer adhered on the adhesive layer of the printing tape is transferred onto the printing tape after the ink ribbon has passed through the separating member, and
the ink ribbon is reeled in the ink ribbon reel-in spool.

7. The tape cassette according to claim 2, wherein
the tape cassette can be mounted onto or removed from a tape printer having a thermal head and a platen roller,
a contact location where the adhesive layer and the ink layer come into contact with each other is clamped between the thermal head and the platen roller when the tape cassette is mounted onto the tape printer,
the thermal head is brought into contact at the contact location with an adhesive layer free surface of the printing tape, and
the ink layer of the ink ribbon is adhered onto a heated portion of the adhesive layer which exhibits self-adhesive properties upon being heated selectively by the thermal head.

8. The tape cassette according to claim 7, wherein a release agent layer is applied on the adhesive layer free surface of the printing tape.

9. A tape printer comprising:
a tape cassette including an ink ribbon having a base film coated with an ink layer thereon, a printing tape having a transparent film with an adhesive layer formed on one surface thereof, and a cassette case housing the ink ribbon and the printing tape; and
a pair of conveying rollers conveying the printing tape discharged from a tape-discharging port of the tape cassette, wherein
the adhesive layer starts exhibiting self-adhesive properties upon being heated, and
the pair of conveying rollers includes a heat roller heating the printing tape discharged.

10. The tape printer according to claim 9, wherein the heat roller is brought into contact at a transparent film side of the printing tape.

11. The tape printer according to claim 9, wherein a heating temperature of the heat roller is higher than a temperature at which the adhesive layer starts exhibiting adhesive properties and lower than a temperature at which an ink of the ink layer melts.

12. The tape printer according to claim 9, further comprising a drive control mechanism driving and controlling a heat-generating part of the thermal head, wherein
the heat-generating part of the thermal head is driven and controlled by the drive control mechanism so that the ink layer transferred onto the adhesive layer of the printing tape through the heat-generating part thereof is visible as a normal image when the printing tape is seen from the transparent film side of the printing tape.

13. The tape printer according to claim 9, further comprising a tape cutter cutting the printing tape, arranged between the tape discharging port and the pair of conveying rollers.
